(19) United States
(12) Patent Application Publication
(10) Pub. No.: US 2018/0253158 A1
(43) Pub. Date: Sep. 6, 2018

(54) HEIGHT ADJUSTABLE JOYSTICK DEVICE

(71) Applicant: BENQ CORPORATION, Taipei (TW)

(72) Inventors: Jing-Ren CHEN, Taichung City (TW); Chia-Liang HSU, New Taipei City (TW); Wei-Chieh CHEN, Taoyuan City (TW); Ching-Lin YEH, Taoyuan City (TW); Yu-Shuo FAN, Taipei City (TW)

(73) Assignee: BENQ CORPORATION, Taipei (TW)

(21) Appl. No.: 15/904,440

(22) Filed: Feb. 26, 2018

(30) Foreign Application Priority Data
Mar. 1, 2017 (CN) 201710115885.3

(51) Int. Cl. G06F 3/0338; G05G 9/047; G06F 3/038; A63F 13/24

(52) U.S. Cl. CPC G06F 3/0338; G05G 9/047; A63F 2300/1043; A63F 13/24; G06F 3/0383

(57) ABSTRACT

A height adjustable joystick device including a base, a manual operation body and a height adjustment structure is provided. The manual operation body is located on the base and includes a joystick. The joystick is located on an operating surface of the manual operation body. The height adjustment structure is arranged between the base and the manual operation body, and includes a positioning member, a moving member and a releasing member, wherein the operating surface and the base have a height difference, and the moving member and the positioning member can be engaged with each other. The releasing member is used for releasing the positioning member and the moving member is moved to a second position from a first position to adjust the height difference between the operating surface and the base when the positioning member is moved to a release position from a positioning position.

This application claims the benefit of People's Republic of China application Serial No. 201710115885.3, filed Mar. 1, 2017, the subject matter of which is incorporated herein by reference.

### BACKGROUND OF THE INVENTION

### Field of the Invention

The invention relates in general to a joystick device, and more particularly to a height adjustable joystick device.

### Description of the Related Art

Currently, the devices used for operating computer games include mouse, keyboard and joystick, but the mouse and the keyboard are inferior to the joystick in terms of operability and the sense of immediacy. The joystick having a simple structure, creating good hand feeling, and providing flexible operation to use, and therefore has become one of the game players' favorite devices. However, the current operating device is incapable of adjusting the height or the inclination angle of the joystick according to the user's needs.

### SUMMARY OF THE INVENTION

The invention is directed to a height adjustable joystick device capable of adjusting the height and/or the inclination angle of the operating surface on which the joystick is located according to the user's needs.

According to one embodiment of the invention, a height adjustable joystick device including a base, a manual operation body and a height adjustment structure is provided. The manual operation body is located on the base and includes a joystick. The joystick is located on an operating surface of the manual operation body. The height adjustment structure is arranged between the base and the manual operation body, and includes a positioning member, a moving member and a releasing member, wherein the operating surface and the base have a height difference, and the moving member and the positioning member can be engaged with each other. The releasing member is used for releasing the positioning member, and the moving member is moved to a second position from a first position to adjust the height difference between the operating surface and the base when the positioning member is moved to a release position from a positioning position.

A height adjustable joystick device including a base, a manual operation body and a height adjustment structure is provided. The manual operation body is located on the base and includes a joystick located on an operating surface of the manual operation body. The height adjustment structure is arranged between the base and the manual operation body to adjust the height difference between the operating surface and the base. The bottom of the base has a bearing surface extending along the width direction of the joystick device, so that the base can be stably placed on the desk or the user's laps.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1A-1C are external views of a height adjustable joystick device according to an embodiment of the invention.

FIGS. 2A and 2B are operation diagrams of a sliding mechanism located inside the manual operation body.

FIGS. 3A-3C are operation diagrams of a height adjustment structure.

FIGS. 4A and 4B are external views of a height adjustable joystick device according to another embodiment of the invention.

FIGS. 5A-5C are operation diagrams of a height adjustment structure.

### DETAILED DESCRIPTION OF THE INVENTION

Detailed descriptions of the invention are disclosed below with a number of embodiments. However, the disclosed embodiments are for explanatory and exemplary purposes only, not for limiting the scope of protection of the invention.

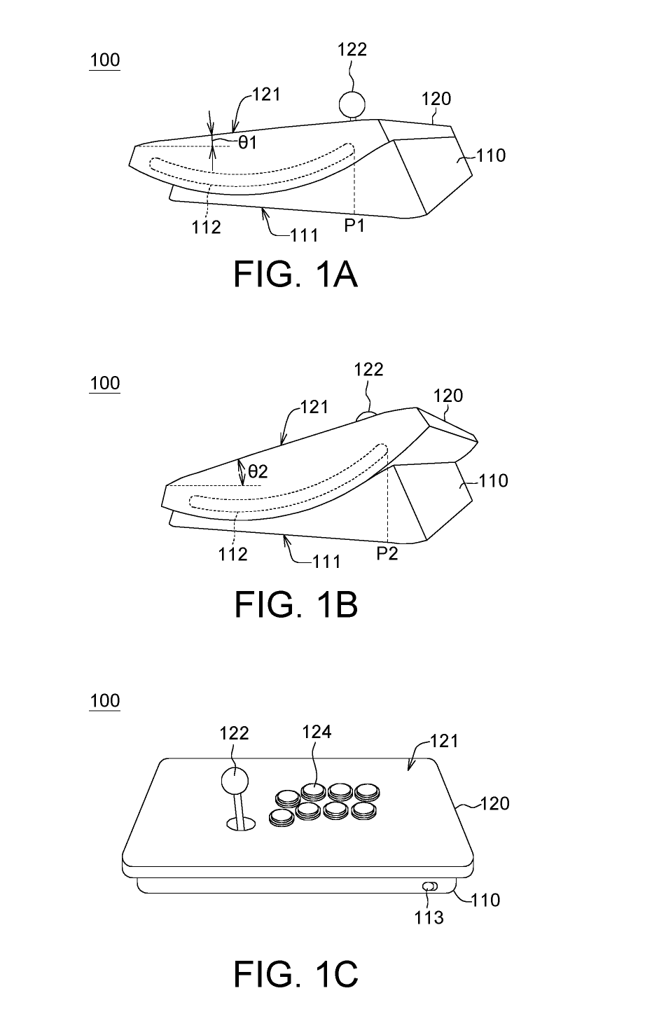

Refer to FIGS. 1A-1C. The height adjustable joystick device 100 according to an embodiment of the invention includes a base 110 and a manual operation body 120. The electronic elements such as the circuit board and the signal transmitting/receiving units disposed in the manual operation body 120 are known conventional elements and are not described in detail here. The manual operation body 120 is located on the base 110 and includes a joystick 122 located on an operating surface 121 of the manual operation body 120. Besides, the operating surface 121 can further have a press key 124 disposed thereon for the user select or set the game. The user can place the base 110 of the height adjustable joystick device 100 on the desktop or their laps. The bottom of the base 110 has a bearing surface 111. The bearing surface 111 is substantially a horizontal plane, has a large area and is very stable.

Refer to FIGS. 1A and 1B. The operating surface 121 and the base 110 have a height difference, and the manual operation body 120 can slide with respect to the base 110 to adjust the height difference and/or the angle of inclination between the operating surface 121 and the base 110. As indicated in FIG. 1A, the operating surface 121 has a first inclination angle θ1 with respect to the base 110. As indicated in FIG. 1B, the operating surface 121 has a second inclination angle θ2 with respect to the base 110. When the user unlocks the press key and pushes the manual operation body 120, the manual operation body 120 can slide for a distance with respect to the base 110, so that the operating surface 121 can change to a second inclination angle θ2 from a first inclination angle θ1. For example, the inclination angle of the operating surface 121 changes to 30° from 10° or larger or changes to 10° or smaller from 30° to match the operating angle needed by the user.

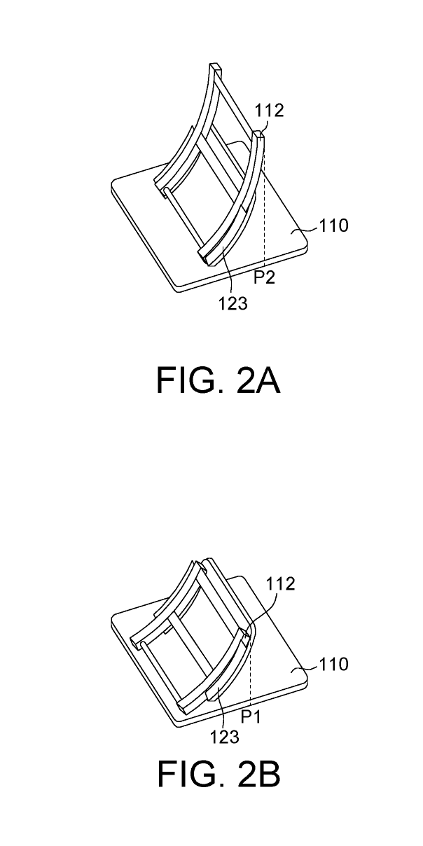

Refer to FIGS. 2A and 2B. For the manual operation body to slide with respect to the base 110, the manual operation body can have a movable sliding rail 112, such as a curved rail or a planar rail, so that the manual operation body can be located on track 123 through the movable sliding rail 112 and slide to a predetermined position (the first position P1 or the second position P2) along the track 123 (such as a curved rail or a planar rail). Then, the movable sliding rail 112 can further be fixed on the predetermined position through the positioning member and maintain at the fixed position to match the user's needs.

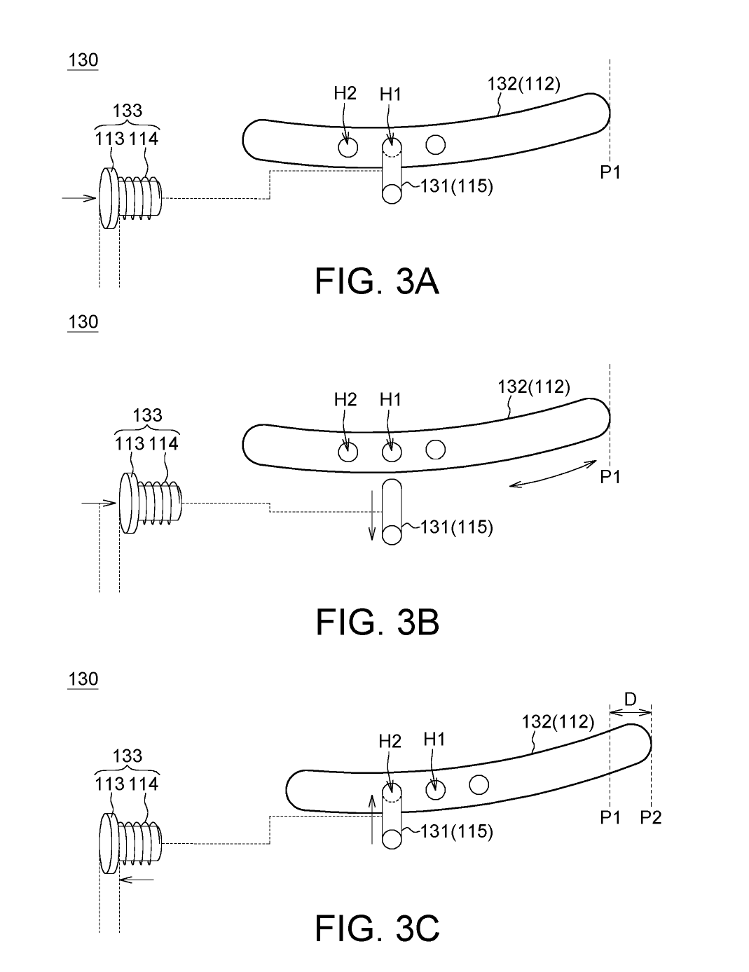

Moreover, in order to adjust the height difference and/or the inclination angle between the operating surface 121 and the base 110, the height adjustable joystick device 100 of the invention further includes a height adjustment structure 130 arranged between the base 110 and the manual operation body 120. Refer to FIGS. 3A-3C. The height adjustment structure 130 includes a positioning member 131, a moving member 132 and a releasing member 133. As indicated in FIG. 3A, the moving member 132 and the positioning member 131 can be engaged with each other, so that the moving member 132 can be fixed at a first position P1. Meanwhile, the releasing member 133 is not pressed, and the positioning member 131 is located at a positioning position. As indicated in FIG. 3B, after the releasing member 133 is pressed, the positioning member 131 is located at a release position, so that the moving member 132 and the positioning member 131 can be separated from each other. Meanwhile, the manual operation body 120 can slide with respect to the base 110. As indicated in FIG. 3C, the user pushes the moving member 132, so that the moving member 132 can be moved to a second position P2 from the first position P1. The distance of movement is denoted by D. Then, the releasing member 133 is released, so that the positioning member 131 is moved to the positioning position from the release position. Meanwhile, the moving member 132 and the positioning member 131 can be engaged with each other, so that the moving member 132 can be fixed at the second position P2. Thus, the height of the joystick device 100 can be adjusted through the above operations as indicated in FIGS. 3A-3C.

Refer to FIGS. 3A-3C. The moving member 132 includes a movable sliding rail 112 located on the manual operation body 120. The positioning member 131 includes a plug 115 located on the base 110. The releasing member 133 includes a button 113 connecting the plug 115 and a spring 114. The spring 114 abuts between the button 113 and the base 110 to provide an elasticity to the button 113. The button 113 and the spring 114 are used for driving the plug 115 to the release position or the positioning position, so that the plug 115 and the movable sliding rail 112 can be separated from each other or can be engaged with each other. In an embodiment, the movable sliding rail 112 at least has a first hole H1 and a second hole H2. As indicated in FIG. 3A, when the movable sliding rail 112 is at the first position P1, the first hole H1 corresponds to the position of the plug 115, so that the plug 115 can be correspondingly inserted into the first hole H1. As indicated in FIG. 3B, when the button 113 is pressed and compresses the spring 114, the plug 115 moves away from the first hole H1, so that the plug 115 and the movable sliding rail 112 can be separated from each other. As indicated in FIG. 3C, when the movable sliding rail 112 is moved to the second position P2, the second hole H2 corresponds to the position of the plug 115, and the button 113 is released and makes the spring 114 restore its original state. Meanwhile, the plug 115 can be correspondingly inserted into the second hole H2, so that the plug 115 and the movable sliding rail 112 can be engaged with each other. In the present embodiment, the quantity of holes can be two or more than two, so that the height of the joystick 122 can be adjusted in multiple stages. Furthermore, the height adjustment structure 130 can have a non-differential mechanism (such as a cam or a ramp) to realize stage-free adjustment of the joystick 122.

Refer to FIG. 1C. In an embodiment, when the button 113 is located on one side of the base 110 facing the user and is pressed by the user to actuate and release the plug 115, the user pushes the manual operation body 120, so that the manual operation body 120 can slide with respect to the base 110 and change the sliding distance. In another embodiment, two buttons 113 can be disposed on the left side and the right side of the base 110. The user can concurrently press the two buttons 113 to release corresponding plugs 115 and accordingly adjust the sliding distance of the movable sliding rail 112. Besides, the button 113 is not limited to the press-type button 113 that can be pushed downwardly, and can also be designed as a push-type button that can be pushed leftward and rightward. The push-type button can be pushed to release the plug 115 and accordingly adjust the sliding distance of the movable sliding rail 112.

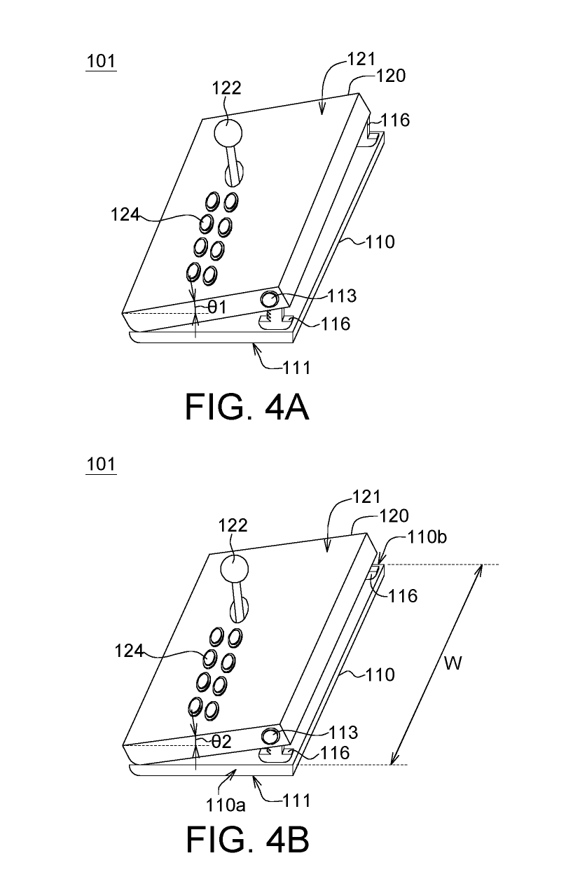

Apart from the manual operation body 120 sliding with respect to the base 110 as disclosed in the above embodiment, another height adjustable joystick device 101 is disclosed in another embodiment as indicated in FIGS. 4A and 4B. The manual operation body 120 can be lifted upwards to an angle with respect to the base 110, so that the operating surface 121 can change to the second inclination angle θ2 from the first inclination angle θ1. As indicated in FIG. 4A, the operating surface 121 has a first inclination angle θ1 with respect to the base 110. As indicated in FIG. 4B, the operating surface 121 has a second inclination angle θ2 with respect to the base 110.

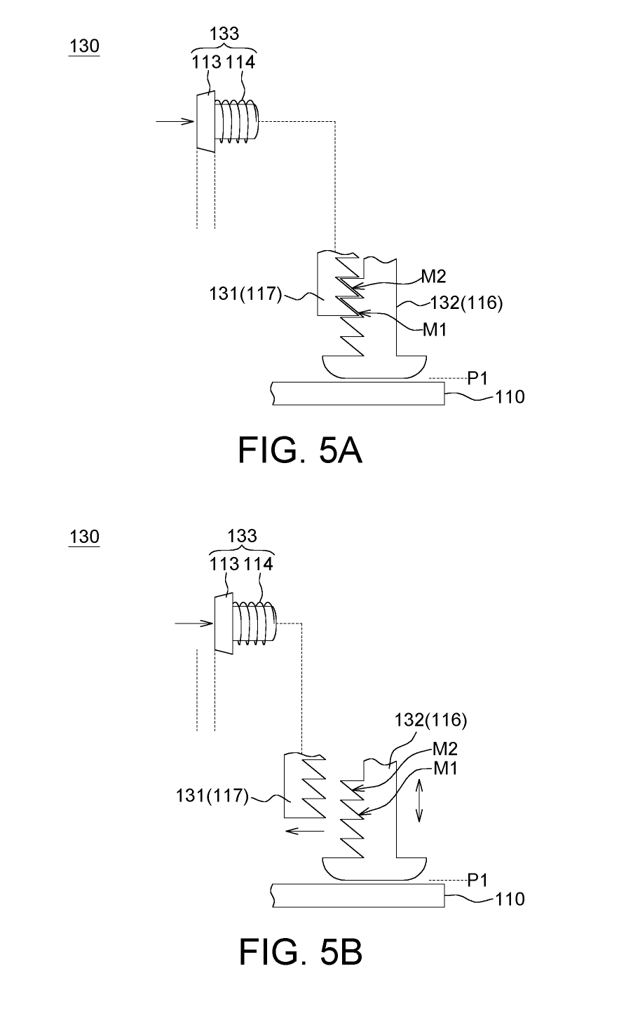

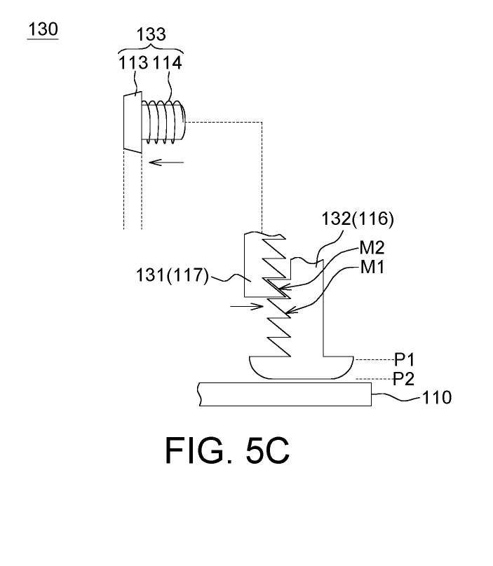

Refer to FIGS. 5A-5C. The height adjustment structure 130 includes a positioning member 131, a moving member 132 and a releasing member 133. The moving member 132 includes a movable pin 116 located on the manual operation body 120, and one end of the movable pin 116 abuts the base 110. The positioning member 131 includes a latch 117 located on the base 110. The releasing member 133 includes a button 113 connecting the latch 117 and a spring 114. The spring 114 abuts between the button 113 and the base 110 to provide an elasticity to the button 113. The button 113 and the spring 114 are used for driving the latch 117 to the release position or the positioning position, so that the latch 117 and movable pin 116 can be separated from each other or can be engaged with each other. In an embodiment, the movable pin 116 at least has a first groove M1 and a second groove M2. As indicated in FIG. 5A, when the movable pin 116 is at the first position P1, the first groove M1 corresponds to the position of the latch 117, so that the latch 117 can be correspondingly inserted into the first groove M1. As indicated in FIG. 3B, when the button 113 is pressed and compresses the spring 114, the latch 117 moves away from the first groove M1, so that the latch 117 and the first groove M1 can be separated from each other. As indicated in FIG. 3C, when movable pin 116 is moved to the second position P2, the second groove M2 corresponds to the position of the latch 117, and the button 113 is released and makes the spring 114 restore its original state. Meanwhile, the latch 117 can be correspondingly inserted into the second groove M2, so that the latch 117 and the movable pin 116 can be engaged with each other. In the present embodiment, the quantity of grooves can be two or more than two, so that the height of the joystick 122 can be adjusted in multiple stages. Furthermore, the height adjustment structure 130 can have a non-differential mechanism (such as a cam or a ramp) to realize stage-free adjustment of the joystick 122.

Refer to FIGS. 4A and 4B. In an embodiment, the button 113 is located on at least one side of the base 110. When the button 113 is pressed by the user to actuate and release the latch 117, the user moves the manual operation body 120 upwards, so that the manual operation body 120 can be lifted upwards and change its angle with respect to the base 110. In another embodiment, two buttons 113 can be disposed on the left side and the right side of the base 110, and only one movable pin 116 is disposed at the center of the manual operation body 120 (in FIG. 4B, two movable pins 116 are illustrated). The user can concurrently press the buttons 113 on the two sides of the base 110 to release the latch 117 and accordingly adjust the height of the movable pin 116. Besides, the button 113 is not limited to the press-type button 113 that can be pushed downwardly, and can also be designed as a push-type button that can be pushed leftward and rightward. The button 113 can be pushed to release the latch 117 and accordingly adjust the height of the movable pin 116.

Refer to FIG. 4B, the bottom of the base 110 has a bearing surface 111 extending along the width direction of the joystick device 101. As indicated in FIG. 4B, the base 110 has a first side 110a and a second side 110b in the width direction of the joystick device 10, and the bearing surface 111 can extend to the second side 110b from the first side 110a. The width W of the bearing surface 111 is at least larger than the width of the user's two laps joined together, so that the base 110 can be stably placed on the user's laps without tilting or skewing.

According to the height adjustable joystick device disclosed in above embodiments of the invention, the height difference between the operating surface of the joystick and the base can be adjusted using a height adjustment structure such as movable rail or movable pin, and the operability of the joystick can be enhanced. In comparison to the conventional joystick, the joystick device of the invention can adjust the height difference and/or the inclination angle between the operating surface and the base, and the bottom of the base can have a bearing surface having a large area, so that the base can be stably placed on the desk or the user's laps. The design of the height adjustment structure conforms with ergonomics and allows the user to operate the joystick more flexibly.

While the invention has been described by way of example and in terms of the preferred embodiment(s), it is to be understood that the invention is not limited thereto. On the contrary, it is intended to cover various modification and similar arrangements and procedures, and the scope of the appended claims therefore should be accorded the broadest interpretation so as to encompass all such modification and similar arrangements and procedures.

What is claimed is:

1. A height adjustable joystick device, comprising:
a base;
a manual operation body located on the base and comprising a joystick, wherein the joystick is located on an operating surface of the manual operation body; and
a height adjustment structure arranged between the base and the manual operation body and comprising a positioning member, a moving member and a releasing member, wherein the operating surface and the base have a height difference, the moving member and the positioning member are engaged with each other, and the releasing member is used for releasing the positioning member and the moving member is moved to a second position from a first position to adjust the height difference between the operating surface and the base when the positioning member is moved to a release position from a positioning position.

2. The height adjustable joystick device according to claim 1, wherein the manual operation body is used to slide for a distance with respect to the base, and the operating surface is changed to a second inclination angle from a first inclination angle in response to the distance.

3. The height adjustable joystick device according to claim 2, wherein the moving member comprises a movable sliding rail located on the manual operation body, the positioning member comprises a plug located on the base, the releasing member comprises a button connecting the plug and a spring, the spring abuts between the button and the base, and the button and the spring are used for driving the plug to the release position or the positioning position, and the plug and the movable sliding rail are separated from each other or engaged with each other in response to that the plug is driven to the release position or the positioning position.

4. The height adjustable joystick device according to claim 3, wherein the movable sliding rail at least has a first hole and a second hole, and the plug is correspondingly inserted into the first hole or the second hole in response to that the movable sliding rail is at the first position or the second position.

5. The height adjustable joystick device according to claim 4, wherein the button located on one side of the base facing a user is pressed by the user to actuate and release the plug, and the manual operation body slides with respect to the base to change the distance in response to that the user pushes the manual operation body.

6. The height adjustable joystick device according to claim 1, wherein the manual operation body is lifted upwards to an angle with respect to the base, and the operating surface is changed to a second inclination angle from a first inclination angle in response to the angle.

7. The height adjustable joystick device according to claim 6, wherein the moving member comprises a movable pin located on the manual operation body, one end of the movable pin abuts the base, the positioning member comprises a latch located on the base, the releasing member comprises a button connecting the latch and a spring, the spring abuts between the button and the base, and the button and the spring are used for driving the latch to the release position or the positioning position, and the latch and the movable pin are separated from each other or engaged with each other in response to that the latch is driven to the release position or the positioning position.

8. The height adjustable joystick device according to claim 7, wherein the movable pin at least has a first groove and a second groove, and the latch is correspondingly engaged in the first groove or the second groove in response to that the movable pin is at the first position or the second position.

9. The height adjustable joystick device according to claim 8, wherein the button located on at least one side of the base is pressed by the user to actuate and release the latch, and the manual operation body is lifted upwards with respect to the base and change the angle in response to that the user moves the manual operation body.

10. The height adjustable joystick device according to claim 1, wherein a bottom of the base has a bearing surface, and the base is stably placed on a desk or user's laps through the bearing surface.

11. A height adjustable joystick device, comprising:
a base;
a manual operation body located on the base and comprising a joystick located on an operating surface of the manual operation body; and
a height adjustment structure arranged between the base and the manual operation body to adjust a height difference between the operating surface and the base,
wherein a bottom of the base has a bearing surface extending along a width direction of the joystick device, and the base is stably placed on a desk or user's laps through the bearing surface.

12. The height adjustable joystick device according to claim 11, wherein the height adjustment structure comprises a positioning member, a moving member and a releasing member, the moving member and the positioning member are engaged with each other, the releasing member is used for releasing the positioning member and the moving member is moved to a second position from a first position to adjust the height difference between the operating surface and the base when the positioning member is moved to a release position from a positioning position.

13. The height adjustable joystick device according to claim 11, wherein the base has a first side and a second side in a width direction of the joystick device, and the bearing surface extends to the second side from the first side.

14. The height adjustable joystick device according to claim 12, wherein the manual operation body is used to slide for a distance with respect to the base, and the operating surface is changed to a second inclination angle from a first inclination angle in response to the distance.

15. The height adjustable joystick device according to claim 14, wherein the moving member comprises a movable sliding rail located on the manual operation body, the positioning member comprises a plug located on the base, the releasing member comprises a button connecting the plug and a spring, the spring abuts between the button and the base, and the button and the spring are used for driving the plug to the release position or the positioning position, and the plug and the movable sliding rail are separated from each other or engaged with each other in response to that the plug is driven to the release position or the positioning position.

16. The height adjustable joystick device according to claim 15, wherein the movable sliding rail at least has a first hole and a second hole, and the plug is correspondingly inserted into the first hole or the second hole in response to that the movable sliding rail is at the first position or the second position.

17. The height adjustable joystick device according to claim 16, wherein the button located on one side of the base facing a user is pressed by the user to actuate and release the plug, and the manual operation body slides with respect to the base to change the distance in response to that the user pushes the manual operation body.

18. The height adjustable joystick device according to claim 12, wherein the manual operation body is lifted upwards to an angle with respect to the base, and the operating surface is changed to a second inclination angle from a first inclination angle in response to the angle.

19. The height adjustable joystick device according to claim 18, wherein the moving member comprises a movable pin located on the manual operation body, one end of the movable pin abuts the base, the positioning member comprises a latch located on the base, the releasing member comprises a button connecting the latch and a spring, the spring abuts between the button and the base, and the button and the spring are used for driving the latch to the release position or the positioning position, and the latch and the movable pin are separated from each other or engaged with each other in response to that the latch is driven to the release position or the positioning position.

20. The height adjustable joystick device according to claim 19, wherein the movable pin at least has a first groove and a second groove, and the latch is correspondingly engaged in the first groove or the second groove in response to that the movable pin is at the first position or the second position, wherein the button located on at least one side of the base is pressed by the user to actuate and release the latch, and the manual operation body is lifted upwards with respect to the base and change the angle in response to that the user moves the manual operation body.
